(19) United States
(12) Patent Application Publication
(10) Pub. No.: US 2026/0300911 A1
(43) Pub. Date: Oct. 1, 2026

(54) PRODUCT MANAGEMENT DEVICE, PRODUCT MANAGEMENT SYSTEM, PRODUCT MANAGEMENT METHOD, AND RECORDING MEDIUM

(71) Applicant: NEC Corporation, Tokyo (JP)

(72) Inventors: Tomoki ISHII, Tokyo (JP); Takahiro MATSUI, Tokyo (JP); Shinji FUNAI, Tokyo (JP); Yoshiya UOTANI, Tokyo (JP)

(73) Assignee: NEC Corporation, Tokyo (JP)

(21) Appl. No.: 19/478,373

(22) PCT Filed: May 18, 2023
(86) PCT No.: PCT/JP2023/018584

§ 371 Date: Oct. 24, 2025

(51) Int. Cl. G06Q 10/087; G06Q 10/0833

(52) U.S. Cl. CPC G06Q 10/08724; G06Q 10/0833

(57) ABSTRACT

A product management device includes, at least one memory storing instructions, and at least one processor configured to execute the instructions to, acquire a display quantity, on a product shelf, of a target product for which a reception request has been received from a customer, acquire a stock information of the target product, in a case where the display quantity is less than a predetermined number, accept the reception request, in a case where a stock quantity of the target product is equal to or more than a predetermined number, and notify at least any one store terminal of delivery information of the target product, in a case where the reception request has been accepted.

### TECHNICAL FIELD

The present disclosure relates to a product management device, a product management system, a product management method, and a recording medium.

### BACKGROUND ART

There is a case where a product to be purchased is not arranged on a product shelf when a customer visits a store. There is a technique for avoiding a loss of an opportunity that would be obtained if the product is arranged on the product shelf, in the store.

For example, PTL 1 discloses an electronic shelf label management server that transmits product information including at least one of scheduled arrival time information and scheduled display time information of a product, to an electronic shelf label terminal. PTL 2 discloses an information processing device that guides to replenish products to a child store, in consideration of a product stock of the child store or a mother store, with respect to a product and a quantity of the product that a customer desires to purchase in the small child store near the mother store.

### CITATION LIST

### Patent Literature

PTL 2: WO 2020/195612 A 1

### SUMMARY OF INVENTION

### Technical Problem

By the way, even if there is no product on a product shelf in a store, a predetermined or more stock quantity of the product may be in a backyard. In a case where a customer purchases the product in the backyard, the customer needs to talk to an employee. However, there is a possibility that the customer gives up to purchase the product in the store, if there is no employee nearby.

An example of an object of the present disclosure is to provide a product management device that can reduce an opportunity loss caused by a product not being arranged on a product shelf.

### Solution to Problem

A product management device according to one aspect of the present disclosure includes display quantity acquisition means for acquiring a display quantity, on a product shelf, of a target product for which a reception request has been received from a customer, stock acquisition means for acquiring stock information of the target product, in a case where the display quantity is less than a predetermined number, acceptance means for accepting the reception request, in a case where a stock quantity of the target product is equal to or more than a predetermined number, and notification means for notifying at least any one store terminal of delivery information of the target product, in a case where the reception request has been accepted.

A product management system according to one aspect of the present disclosure including a reception request device and the product management device, in which the reception request device includes a display device that is provided on the product shelf of the store and has a button or a touch panel function, and the product management system includes transmission means for transmitting the reception request of the target product, to the product management device, in a case where the reception request of the target product is made by the button or the display device.

A product management method according to one aspect of the present disclosure performed by a computer includes acquiring a display quantity, on a product shelf, of a target product for which a reception request has been received from a customer, acquiring stock information of the target product, in a case where the display quantity is less than a predetermined number, accepting the reception request, in a case where a stock quantity of the target product is equal to or more than a predetermined number, and notifying at least any one store terminal of delivery information of the target product, in a case where the reception request has been accepted.

A recording medium according to one aspect of the present disclosure stores a program for causing a computer to execute processing including acquiring a display quantity, on a product shelf, of a target product for which a reception request has been received from a customer, acquiring stock information of the target product, in a case where the display quantity is less than a predetermined number, accepting the reception request, in a case where a stock quantity of the target product is equal to or more than a predetermined number, and notifying at least any one store terminal of delivery information of the target product, in a case where the reception request has been accepted.

### Advantageous Effects of Invention

According to the present disclosure, it is possible to provide a product management device that can reduce an opportunity loss caused by a product not being arranged on a product shelf.

### BRIEF DESCRIPTION OF DRAWINGS

FIG. 1 is a block diagram illustrating a product management device according to the present disclosure.

FIG. 2 is a diagram illustrating a hardware configuration in which the product management device according to the present disclosure is achieved by a computer device and its peripheral devices.

FIG. 3 is a flowchart illustrating an operation of the product management device according to the present disclosure.

FIG. 4 is a block diagram illustrating a product management system according to the present disclosure.

FIG. 5 is a diagram for explaining an example of a place where a reception requesting device according to the present disclosure is installed.

FIG. 6 is an example of a screen for requesting reception, in the present disclosure.

FIG. 7 is a flowchart illustrating an outline of an operation of the product management system according to the present disclosure.

FIG. 8 is a block diagram illustrating the product management system according to the present disclosure.

FIG. 9 is a flowchart illustrating an outline of the operation of the product management system according to the present disclosure.

FIG. 10 is a block diagram illustrating the product management system according to the present disclosure.

FIG. 11 is a flowchart illustrating an outline of the operation of the product management system according to the present disclosure.

FIG. 12 is a block diagram illustrating the product management system according to the present disclosure.

### EXAMPLE EMBODIMENT

Hereinafter, example embodiments of a product management device, a product management system, a product management method, and a non-transitory recording medium for recording a program according to the present disclosure will be described in detail with reference to the drawings. The present example embodiment does not limit the disclosed technology.

### First Example Embodiment

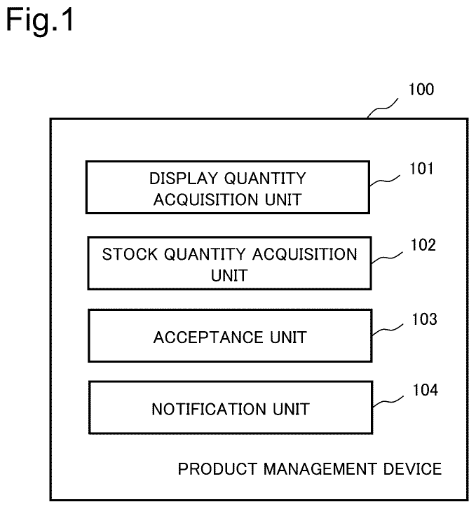

FIG. 1 is a block diagram illustrating a product management device 100 according to the present example embodiment. As illustrated in FIG. 1, the product management device 100 includes a display quantity acquisition unit 101, a stock quantity acquisition unit 102, an acceptance unit 103, and a notification unit 104.

The product management device 100 is a device that enables a customer to request reception of a product, in a case where the product that the customer desires to purchase is not displayed on a product shelf and a stock quantity of the product in a store is equal to or more than a predetermined number. The product management device 100 aggregates management information such as a display quantity or a stock quantity of each product handled in the store. For example, the product management device 100 may be installed in a backyard or the like of the store and include a Point of Sale (POS) server device which is a host device of a POS terminal in the store.

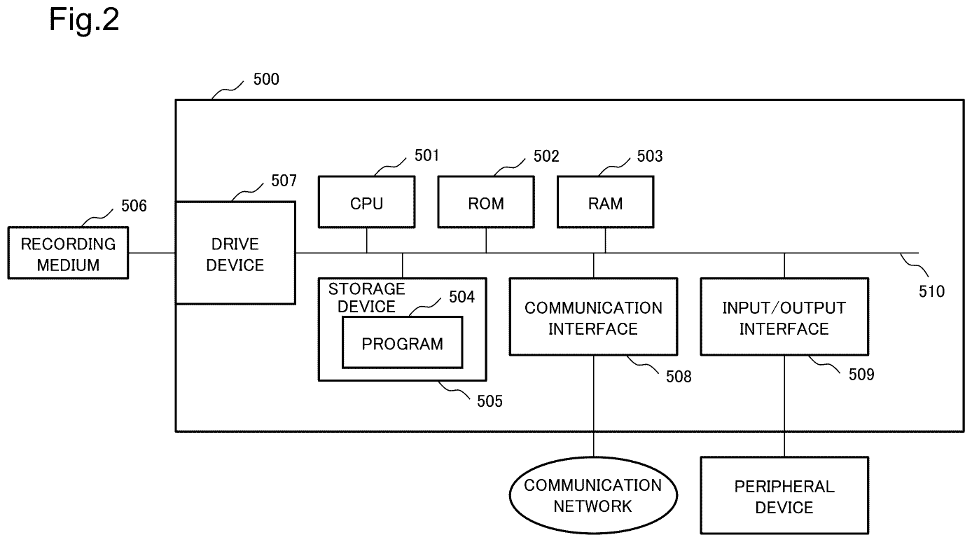

FIG. 2 is a diagram illustrating an example of a hardware configuration in which the product management device 100 according to a first example embodiment of the present disclosure is achieved by a computer device 500 including a processor. As illustrated in FIG. 2, the product management device 100 includes a Central Processing Unit (CPU) 501, a memory such as a Read Only Memory (ROM) 502 and a Random Access Memory (RAM) 503, a storage device 505 such as a hard disk that stores a program 504, a communication interface 508 for network connection, and an input/output interface 509 that inputs and outputs data. In the first example embodiment, the product management device 100 is connected to each component via a bus 510.

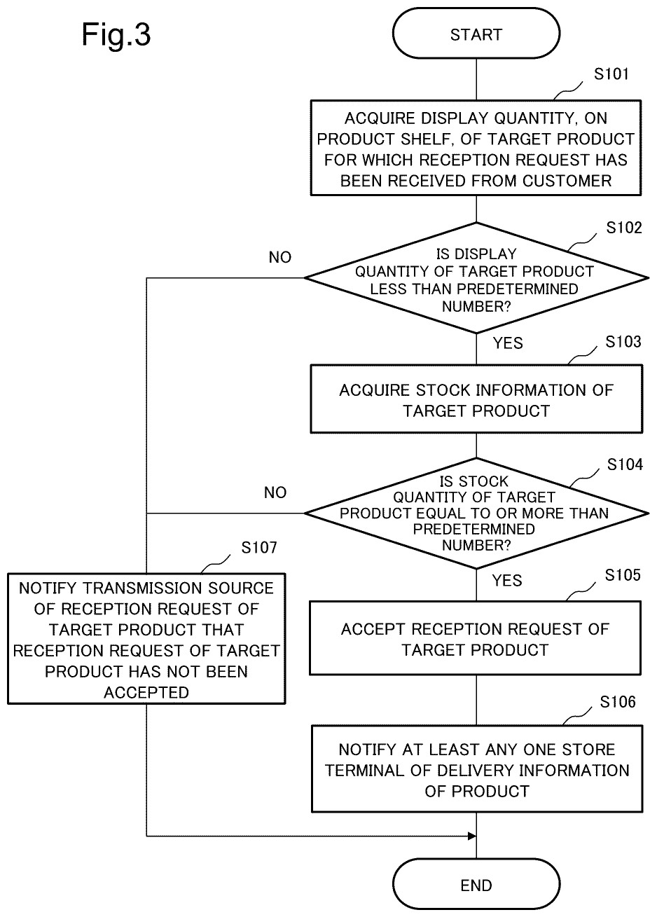

The CPU 501 operates an operating system to control the entire product management device 100 according to the first example embodiment of the present invention. The CPU 501 reads a program and data onto a memory from a recording medium 506 attached to a drive device 507 or the like, for example. The CPU 501 functions as the display quantity acquisition unit 101, the stock quantity acquisition unit 102, the acceptance unit 103, and the notification unit 104 and a part thereof in the first example embodiment, and executes processing or a command in the flowchart illustrated in FIG. 3 to be described later based on a program.

Examples of the recording medium 506 include, for example, an optical disc, a flexible disk, a magnetic optical disc, an external hard disk, or a semiconductor memory. The semiconductor memory, which is one of recording media, is a non-volatile storage device and records programs therein. The program may be downloaded from an external computer (not illustrated) connected to a communication network.

As described above, the product management device 100 illustrated in FIG. 1 is achieved by computer hardware illustrated in FIG. 2. However, means for achieving each unit included in the product management device 100 of FIG. 1 is not limited to the configuration described above. The product management device 100 may be achieved by one physically coupled device, or may be achieved by a system including a plurality of devices obtained by connecting two or more physically separated devices in a wired or wireless manner.

The display quantity acquisition unit 101 acquires a display quantity on the product shelf of a target product for which a reception request has been received from the customer. The display quantity acquisition unit 101 acquires the display quantity of the target product obtained, for example, from a camera or the like or a weight sensor or the like provided on the product shelf. The display quantity acquisition unit 101 outputs the acquired display quantity of the target product to the stock quantity acquisition unit 102.

In a case where the display quantity of the target product is less than a predetermined number, the stock quantity acquisition unit 102 acquires stock information of the target product. For example, the term less than the predetermined number is less than a predetermined display quantity and is, for example, a display quantity when no target product is displayed or a display quantity with which the target products displayed on the product shelf are predicted to be sold out within a predetermined time, based on a sales volume of the target product so far. Even if the display quantity of the target product is equal to or more than the predetermined display quantity, in a case where the display quantity is less than the number of products for which the reception request has been received from the customer, the stock quantity acquisition unit 102 may acquire the stock information of the target product.

For example, the stock quantity acquisition unit 102 acquires a stock quantity in the backyard, using a camera or the like or a weight sensor or the like placed in the backyard of the store. The stock quantity acquisition unit 102 may acquire a stock quantity of the target product registered in the storage device 505 or the POS server. As described later, the stock quantity acquisition unit 102 does not need to count a target product, for which a reception request has been accepted, associated with a reception number, as the stock quantity. The stock quantity acquisition unit 102 outputs the acquired stock quantity of the product to the acceptance unit 103.

In a case where the stock quantity of the target product is equal to or more than a predetermined number, the acceptance unit 103 accepts the reception request. The predetermined number or more is a predetermined stock quantity and may be one or more or may be equal to or more than the number of products for which the reception request has been received from the customer. In a case where the stock quantity of the target product is equal to or more than the predetermined number, the acceptance unit 103 accepts the reception request of the target product from the customer and outputs information indicating that the reception request has been accepted to the notification unit 104. On the other hand, in a case where the stock quantity of the target product is not equal to or more than the predetermined number, even if the acceptance unit 103 receives the reception request of the target product from the customer, the acceptance unit 103 does not accept the request and execute processing for delivering the target product. Even if the stock quantity of the product is equal to or more than the predetermined number, in a case where an employee of the store is not available and a predetermined time or more is required before the target product is received, the acceptance unit 103 does not need to accept the reception request.

In a case of accepting the reception request of the target product, the notification unit 104 notifies any store terminal of delivery information of the target product. The store terminal is, for example, a terminal device of an employee such as a display installed in the backyard of the store or a terminal carried by the employee. In a case where the acceptance unit 103 accepts the reception request of the target product, the notification unit 104 may notify the store terminal of the delivery information indicating at least one of a target product reception place or reception time. The terminal to which the delivery information is notified by the notification unit 104 may be a terminal carried by a person in charge of a sales floor of the target product.

In addition, in a case of accepting the reception request of the target product, the notification unit 104 may notify a transmission source of the reception request of the target product, that the reception request of the target product has been accepted. In a case of not accepting the reception request of the target product, the notification unit 104 may notify the transmission source of the reception request of the target product, that the reception request of the target product has not been accepted. The notification unit 104 may store, in the storage device 505 or the POS server, information regarding the target product, for which the reception request has been accepted, in association with the reception number. As a result, it is not necessary to deliver the target product requested to be received to another customer, by not counting the product associated with the reception number as the stock quantity.

FIG. 3 is a flowchart illustrating an outline of an operation of the product management device 100 according to the first example embodiment. The processing according to this flowchart may be executed based on program control by the processor described above. The processing according to this flowchart is executed, for example, at a timing when the product management device 100 receives the reception request of the target product from the customer.

As illustrated in FIG. 3, first, the display quantity acquisition unit 101 acquires the display quantity on the product shelf of the target product for which the reception request has been received from the customer (step S101). In a case where the display quantity of the target product is less than the predetermined number (S102; YES), the stock quantity acquisition unit 102 acquires the stock information of the target product (step S103). Next, in a case where the stock of the target product is equal to or more than the predetermined number (S104; YES), the acceptance unit 103 accepts the reception request of the target product (step S105). Next, the notification unit 104 notifies at least any one store terminal of the delivery information of the target product (step S106). On the other hand, in a case where the display quantity of the target product is not less than the predetermined number in step S102 (S102; NO), the stock quantity acquisition unit 102 does not acquire the stock information of the target product, and the notification unit 104 notifies the transmission source of the reception request of the target product, that the reception request of the target product has not been accepted (step S107). In a case where the stock quantity of the target product is not equal to or more than the predetermined number in step S102 (S104; NO), the acceptance unit 103 does not accept the reception request of the target product, and the notification unit 104 notifies the transmission source of the reception request of the target product, that the reception request of the target product has not been accepted (step S107). As described above, the product management device 100 ends the processing.

In the present example embodiment, in a case where the display quantity of the target product for which the reception request has been received from the customer is less than the predetermined number, the stock quantity acquisition unit 102 acquires the stock information of the target product. Next, in a case where the stock quantity of the target product is equal to or more than the predetermined number, the acceptance unit 103 accepts the reception request of the target product. Then, the notification unit 104 notifies at least any one store terminal of the delivery information of the target product. As a result, even if there is no employee nearby, it is possible to reduce an opportunity loss caused by not arranging a product desired by the customer on the product shelf.

### Modification of First Example Embodiment

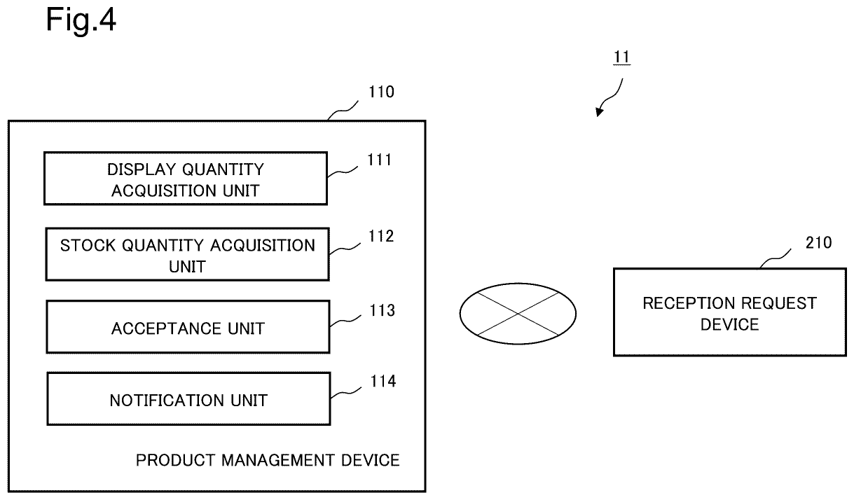

Subsequently, a product management system according to a modification of the first example embodiment will be described. FIG. 4 is a block diagram illustrating a product management system 11 according to the present disclosure. As illustrated in FIG. 4, the product management system 11 includes a product management device 110 and a reception request device 210 and is connected to the product management device 110 and the reception request device 210 via a network. The product management device 110 has a configuration similar to the product management device 100 according to the first example embodiment.

The reception request device 210 is a request device for requesting to receive the target product by the customer. The reception request device 210 is, for example, a display device that is provided on the product shelf on which the products are displayed and has a button that can be pressed by the customer or a touch panel function. Upon detecting the reception request of the target product from the customer, the reception request device 210 transmits information regarding the reception request to the product management device 110, via the communication interface 508.

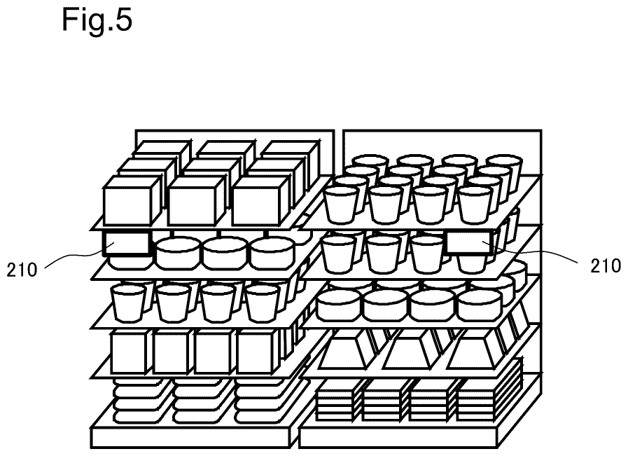

FIG. 5 is a diagram for explaining an example of a place where the reception request device 210 according to the present disclosure is installed. Although the display device is provided as the reception request device 210, for each product shelf in the example in FIG. 5, the number and positions of the installed reception request devices 210 are not limited to those in the example in FIG. 5. For example, the reception request device 210 may be installed on each shelf of the product shelf, and an electronic shelf label of each product may have a function of the reception request device 210.

In a case where the reception request device 210 is the button, the button has a configuration that can specify whether the reception request device 210 is associated with each product and for which product a reception request is made when the button is pressed. In a case where the reception request device 210 is the button, when detecting that the button is pressed, the reception request device 210 transmits the reception request of the target product to the product management device 110. In this case, the reception request device 210 may transmit a time when the reception request is made, as information for specifying the reception request. In a case where the reception request device 210 includes a printer or the like, it is possible to cause the printer to print the reception number for specifying the information regarding the target product requested to be received and the reception request.

In a case where the reception request device 210 is the display device having the touch panel function, it is possible to display a screen used to accept the reception request of the target product on the display device and to request to receive the target product by a touch panel operation. In this case, the customer may specify the target product requested to be received on the screen of the display device.

In a case where the reception request device 210 is the button or the display device, the reception request device 210 may include a Near Field Communication (NFC) reader and may acquire a unique identifier stored in an IC chip in a customer terminal carried by the customer, using the NFC reader and transmit the identifier to the product management device 110, as a user identifier related to the customer who has requested the reception. In a case where an application program for shopping at the store is installed in the customer terminal, the reception request device 210 may notify that the reception request of the target product is made on the application program on the customer terminal, by the Bluetooth (registered trademark) or may further notify the reception number for specifying the reception request.

The reception request device 210 may be the customer terminal such as a tablet or a smartphone carried by the customer. In this case, the application program for shopping at the store is installed, and the request for receiving the target product can be made by an operation on the application program, if the customer is not in the store. In a case where the customer is in the store, for example, the target product requested to be received can be specified by reading a two-dimensional code displayed on a shelf label.

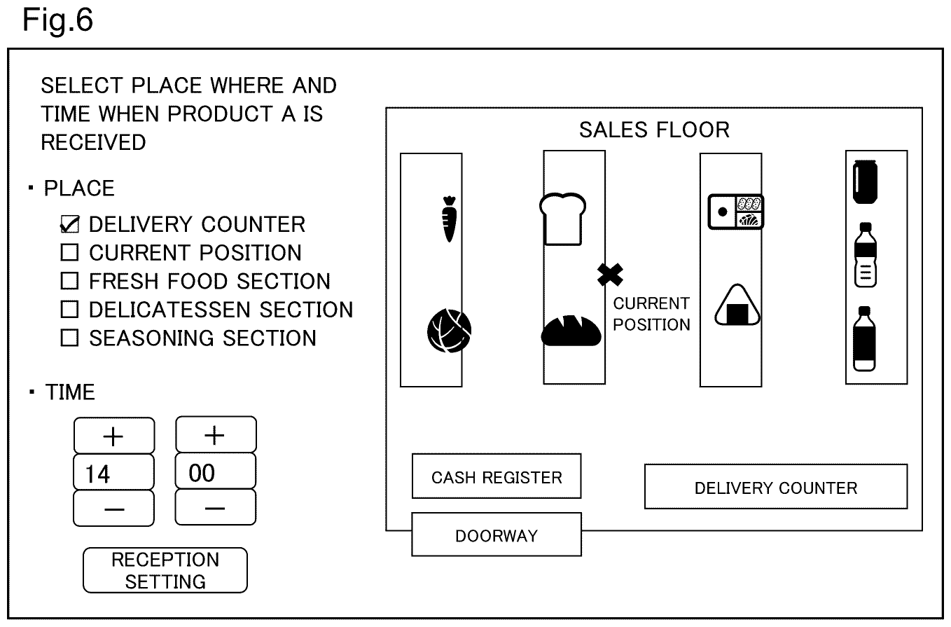

FIG. 6 is an example of a screen for requesting reception, in the present disclosure. In the example in FIG. 6, an example of a screen in a case where the reception request device 210 is the display device or the customer terminal is illustrated. In the example in FIG. 6, the reception request device 210 displays a screen for accepting the reception place and the reception time of the target product. In this case, the reception request device 210 displays a place where reception is possible and a time when the reception is possible in a selectable mode. Although the example of the screen in FIG. 6 assumes a case where the target product is received in the store, the place where the target product is received may be a home or a specific place other than the home.

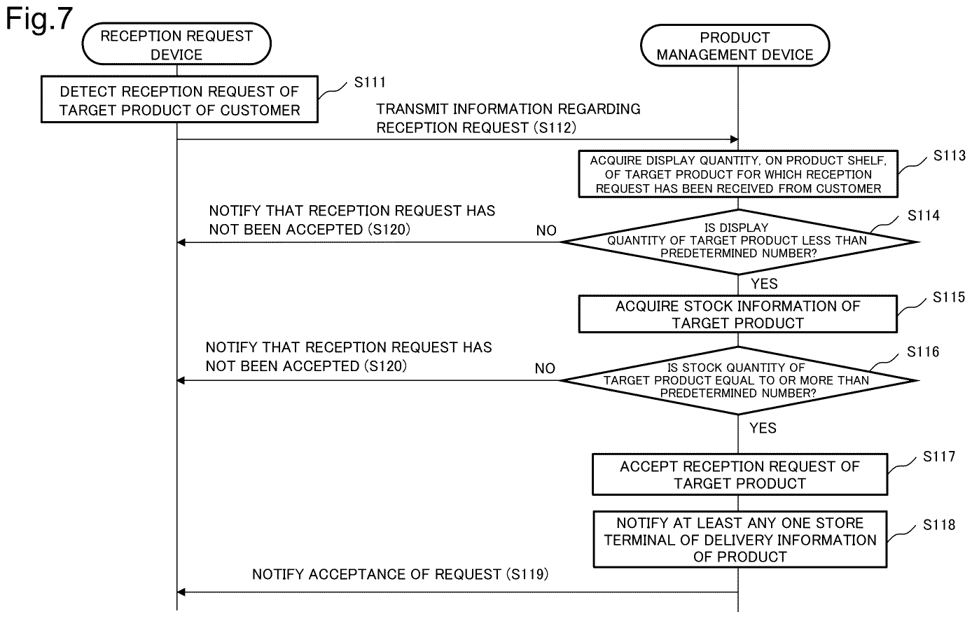

FIG. 7 is a flowchart illustrating an outline of an operation of the product management system 11 according to the modification of the first example embodiment. The processing according to this flowchart may be executed based on program control by the processor described above.

As illustrated in FIG. 7, first, when detecting the reception request of the target product from the customer (step S111), the reception request device 210 transmits information regarding the reception request to the product management device 110 (step S112).

In the product management device 110, a display quantity acquisition unit 111 acquires the display quantity of the target product, on the product shelf, for which the reception request has been received from the customer, received from the reception request device 210 (step S113). In a case where the display quantity of the target product is less than the predetermined number (S114; YES), the stock quantity acquisition unit 112 acquires the stock information of the target product (step S115). In a case where the stock quantity of the target product is equal to or more than the predetermined number (S116; YES), the acceptance unit 113 accepts the reception request of the target product (step S117). Next, a notification unit 114 notifies at least any one store terminal of the delivery information of the target product (step S118). The notification unit 114 notifies the reception request device 210 that the reception request of the target product has been accepted (step S119).

On the other hand, in a case where the display quantity of the target product is not less than the predetermined number in step S114 (S114; NO), the stock quantity acquisition unit 112 does not acquire the stock information of the target product, and the notification unit 114 notifies the reception request device 210 that the reception request has not been accepted (step S120). In a case where the stock quantity of the target product is not equal to or more than the predetermined number in step S116 (S116; NO), the acceptance unit 113 does not accept the reception request of the target product, and the notification unit 114 notifies the reception request device 210 that the reception request of the target product has not been accepted (step S120). As described above, the product management system 11 ends the processing.

In the present modification, upon detecting the reception request of the target product from the customer, the reception request device 210 transmits the reception request to the product management device 110. When the product management device 110 receives the reception request of the target product from the reception request device 210, the acceptance unit 113 accepts the reception request of the target product, based on the display quantity and the stock quantity of the target product on the product shelf, and the notification unit 114 notifies the reception request device 210 of a reception result. As a result, if the customer requests the reception of the target product via the reception request device 210, even if there is no employee nearby, it is possible to reduce the opportunity loss caused by not arranging the product desired by the customer on the product shelf.

### Second Example Embodiment

Next, a second example embodiment of the present disclosure will be described in detail with reference to the drawings. Hereinafter, duplicated content with the above description will not be described to the extent that the description of the present example embodiment is not unclear. In the present example embodiment, when a customer requests reception of a target product via a reception request device 220, in a case where a display quantity of the target product on a product shelf is less than a predetermined number and a stock quantity of the target product is not equal to or more than the predetermined number, information regarding a delivery status of the target product is output to the reception request device 220.

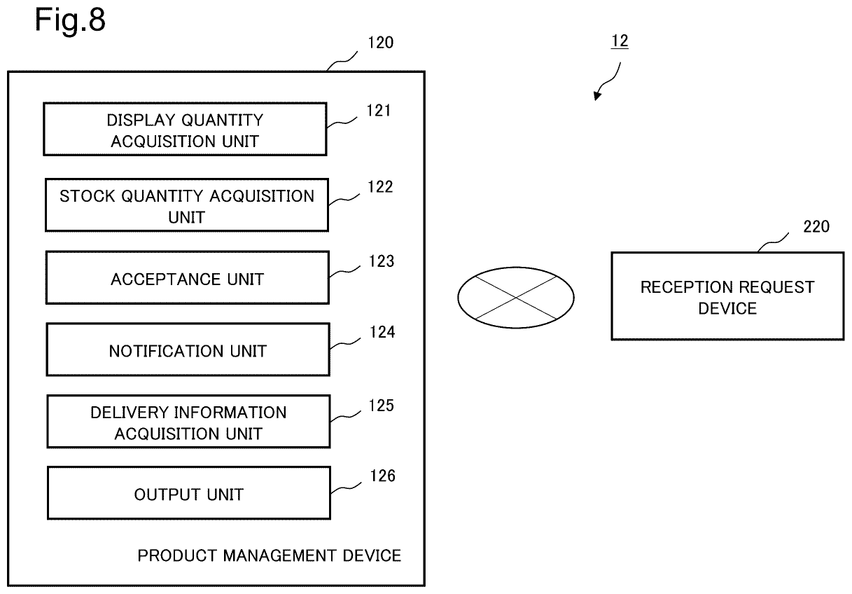

FIG. 8 is a block diagram illustrating a product management system 12 according to the second example embodiment. A function of each of a product management device 120 and the reception request device 220 in the product management system 12 can be, of course, achieved by hardware, similarly to the computer device illustrated in FIG. 2 and can be achieved by a computer device based on program control and software.

Referring to FIG. 8, the product management device 120 includes a display quantity acquisition unit 121, a stock quantity acquisition unit 122, an acceptance unit 123, a notification unit 124, a delivery information acquisition unit 125, and an output unit 126. The display quantity acquisition unit 121, the stock quantity acquisition unit 122, the acceptance unit 123, and the notification unit 124 have configurations similar to those of the related components in the first example embodiment. In the present example embodiment, information regarding a delivery vehicle that delivers the target product to a store where reception is requested and a delivery route of the delivery vehicle are stored in a storage device 505 in association. The delivery route includes a delivery schedule of the delivery vehicle, and a delivery order to each delivery destination where the delivery vehicle delivers a product and an arrival time, a departure time, or the like at each delivery destination are associated.

In a case where the stock quantity of the target product is not equal to or more than the predetermined number, the delivery information acquisition unit 125 acquires delivery information regarding the delivery status of the target product. The delivery information is information regarding a stage of the target product from a time when the target product is loaded on the delivery vehicle at a delivery center to a time when the target product is displayed on the product shelf of the store where the customer has requested to receive the target product, and is, for example, information indicating whether the delivery vehicle loaded with the target product has departed from the delivery center, which delivery destination on the delivery route the delivery vehicle stops, or whether the delivery vehicle has arrived at the store where the customer has requested to receive the target product. For example, the delivery information acquisition unit 125 acquires the delivery information of the target product loaded on the delivery vehicle, based on the current time and the delivery schedule of the delivery vehicle.

The output unit 126 outputs the delivery information. In the present example embodiment, the output unit 126 outputs the delivery information to the reception request device 220 which is a transmission source of the reception request of the target product. The output unit 126 may further output the delivery information of the target product to a store terminal. For example, the output unit 126 outputs that the target product has left a delivery destination visited immediately before the store where the customer has requested to receive the target product and is scheduled to arrive within a predetermined time. The output unit 126 may further output a screen for accepting the reception request of the target product. In this case, the acceptance unit 123 further accepts a reception request input to the screen. An operation of the notification unit 124 in a case where the acceptance unit 123 accepts the reception request is similar to that of the notification unit 104 in the first example embodiment.

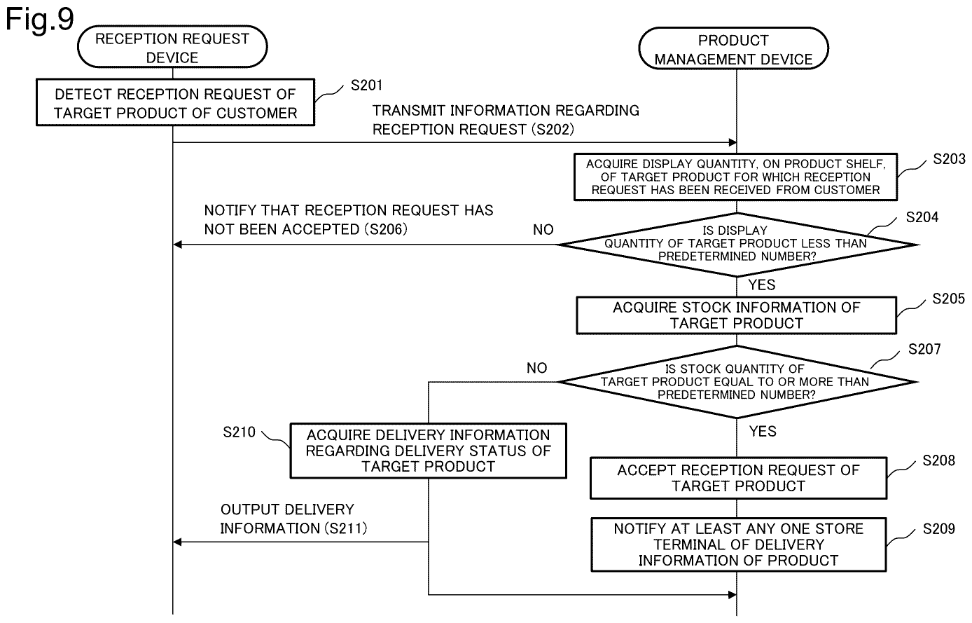

FIG. 9 is a flowchart illustrating an outline of an operation of the product management system 12 according to the second example embodiment. The processing according to this flowchart may be executed based on program control by the processor described above.

As illustrated in FIG. 9, first, when detecting a reception request of a predetermined product from the customer (step S201), the reception request device 220 transmits information regarding the reception request to the product management device 120 (step S202).

In the product management device 120, the display quantity acquisition unit 121 acquires the display quantity of the target product, on the product shelf, for which the reception request has been received from the reception request device 220 (step S203). In a case where the display quantity of the target product is less than the predetermined number (S204; YES), the stock quantity acquisition unit 122 acquires stock information of the target product (step S205). On the other hand, in a case where the display quantity of the target product is not less than the predetermined number (S204; NO), the notification unit 124 notifies the reception request device 220 that the reception request of the target product has not been accepted (step S206).

Next, in a case where the stock quantity of the target product is equal to or more than the predetermined number (S207; YES), the acceptance unit 123 accepts the reception request of the target product (step S208). Next, the notification unit 124 notifies at least any one store terminal of delivery information of the target product (step S209). On the other hand, in a case where the stock quantity of the target product is not equal to or more than the predetermined number in step S207 (step S207; NO), the delivery information acquisition unit 125 acquires the delivery information regarding the delivery status of the target product (step S210). Next, the output unit 126 outputs the delivery information to the reception request device 220 (step S211). As described above, the product management system 12 ends the processing.

In the present example embodiment, in a case where the stock quantity of the target product is not equal to or more than the predetermined number, the delivery information acquisition unit 125 acquires the delivery information regarding the delivery status of the target product. Then, the output unit 126 outputs the delivery information to the reception request device 220. As a result, even if there is no stock of the target product desired by the customer, it is possible to notify the customer that the target product is expected to arrive.

In the present example embodiment, even if the stock quantity of the target product is equal to or more than the predetermined number, the delivery information acquisition unit 125 may acquire the delivery information regarding the delivery status of the target product. That is, even in a case where the stock quantity of the target product is equal to or more than the predetermined number in step S207 in the flowchart in FIG. 9 (S207; YES), the delivery information acquisition unit 125 may acquire the delivery information regarding the delivery status of the target product (step S210), and the output unit 126 may output the delivery information to the reception request device 220 (step S211).

### First Modification of Second Example Embodiment

Next, a modification of the present example embodiment will be described. In the present modification, in a case where the display quantity of the target product on the product shelf is less than the predetermined number and the stock quantity of the target product is not equal to or more than the predetermined number, an estimated scheduled arrival time of the target product is output to a reception request device 230, based on the delivery information and position information of the target product.

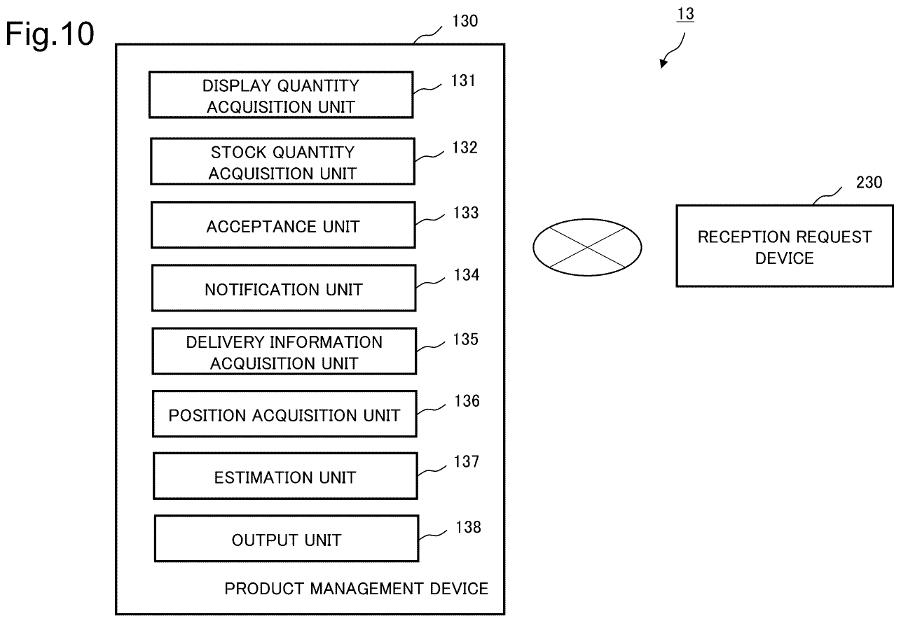

FIG. 10 is a block diagram illustrating a product management system 13 according to the modification of the second example embodiment. A function of each of a product management device 130 and the reception request device 230 in the product management system 13 can be, of course, achieved by hardware, similarly to the computer device illustrated in FIG. 2 and can be achieved by a computer device based on program control and software.

Referring to FIG. 10, the product management device 130 includes a display quantity acquisition unit 131, a stock quantity acquisition unit 132, an acceptance unit 133, a notification unit 134, a delivery information acquisition unit 135, a position acquisition unit 136, an estimation unit 137, and an output unit 138. The display quantity acquisition unit 131, the stock quantity acquisition unit 132, the acceptance unit 133, the notification unit 134, and the delivery information acquisition unit 135 in the product management device 130 have configurations similar to those of the related components in the second example embodiment.

The position acquisition unit 136 acquires the position information of the target product. In the present modification, the position acquisition unit 136 acquires the position information obtained by a Global Positioning System (GPS; registered trademark) of a delivery vehicle terminal of the delivery vehicle that delivers the target product via the communication interface 508. The delivery vehicle terminal is a navigation device installed in each delivery vehicle or a mobile terminal carried by a delivery driver. The position acquisition unit 136 may acquire the position information obtained by recognizing a number or the like of the delivery vehicle by an imaging device provided at a predetermined place on the delivery route such as the delivery center or a delivery destination store. The position acquisition unit 136 may acquire information indicating that the target product is delivered to a store, by detecting that code information of the target product is read for delivery processing, in the store where the customer has requested to receive the target product.

The estimation unit 137 estimates the scheduled arrival time of the target product, based on the delivery information and the position information of the target product. For example, the estimation unit 137 compares a scheduled position of the delivery vehicle on the scheduled delivery route according to the delivery information and a position of the target product, and in a case where these positions are within a predetermined distance, the estimation unit 137 estimates a scheduled time of the target product as in the delivery information. On the other hand, the estimation unit 137 compares the scheduled position on the scheduled delivery route according to the delivery information and the position of the target product, and in a case where the position of the target product is closer to the store where the reception is requested than the scheduled position by the predetermined distance or longer, the estimation unit 137 estimates the scheduled arrival time to be earlier than the schedule, and in a case where the position of the target product is farther from the store where the reception is requested than the scheduled position by the predetermined distance or longer, the estimation unit 137 estimates the scheduled arrival time to be later than the schedule.

The output unit 138 outputs the estimated scheduled arrival time. The output unit 138 outputs the scheduled arrival time to the reception request device 230 which is a transmission source of the reception request of the target product, as in the second example embodiment. The output unit 138 may output the scheduled arrival time of the target product to the store terminal. The output unit 138 may further output the screen for accepting reception request of the target product. In this case, the acceptance unit 133 further accepts the reception request input into the screen. An operation of the notification unit 134 in a case where the acceptance unit 133 accepts the reception request is similar to that of the notification unit 104 in the first example embodiment.

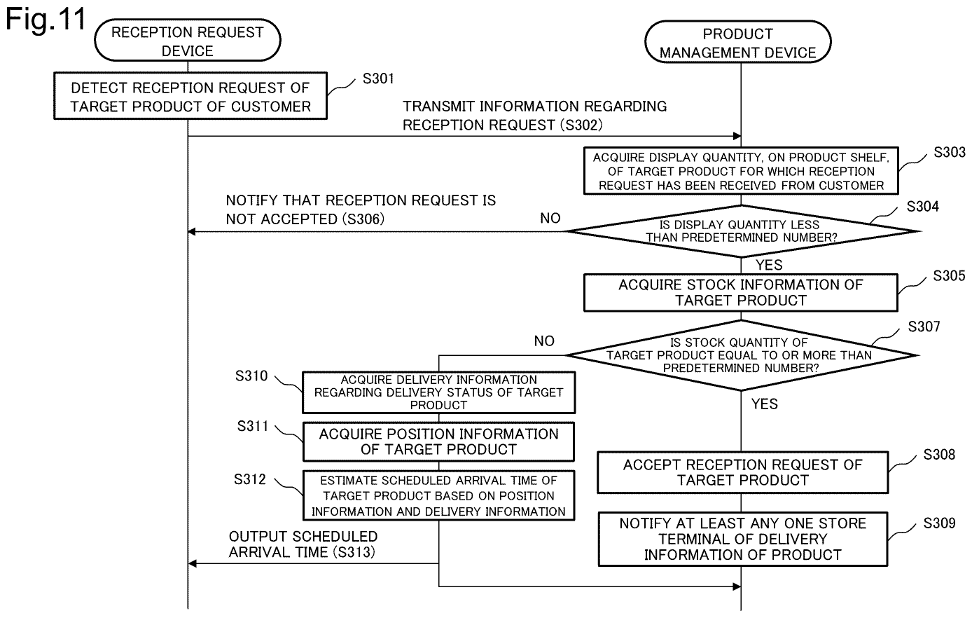

FIG. 11 is a flowchart illustrating an outline of an operation of the product management system 13 according to the modification of the second example embodiment. The processing according to this flowchart may be executed based on program control by the processor described above. A flow of this flowchart in a case where the stock quantity of the target product is not equal to or more than the predetermined number in S307 is different from that in FIG. 9.

As illustrated in FIG. 11, first, when detecting the reception request of the target product from the customer (step S301), the reception request device 230 transmits information regarding the reception request to the product management device 130 (step S302).

In the product management device 130, the display quantity acquisition unit 131 acquires the display quantity of the target product, on the product shelf, for which the reception request has been received from the reception request device 230 (step S303). In a case where the display quantity of the target product is less than the predetermined number (S304; YES), the stock quantity acquisition unit 132 acquires the stock information of the target product (step S305). On the other hand, in a case where the display quantity of the target product is not less than the predetermined number (S304; NO), the notification unit 134 notifies the reception request device 230 that the reception request of the target product has not been accepted (step S306).

Next, in a case where the stock quantity of the target product is equal to or more than the predetermined number (S307; YES), the acceptance unit 133 accepts the reception request of the target product (step S308). Next, the notification unit 134 notifies at least any one store terminal of the delivery information of the target product (step S309). On the other hand, in a case where the stock quantity of the target product is not equal to or more than the predetermined number in step S307 (step S307; NO), the delivery information acquisition unit 135 acquires the delivery information regarding the delivery status of the target product (step S310), and the position acquisition unit 136 acquires the position information of the target product (step S311). Next, the estimation unit 137 estimates the scheduled arrival time of the target product, based on the position information and the delivery information (step S312). Finally, the output unit 138 outputs the scheduled arrival time to the reception request device 230 (step S313). As described above, the product management system 13 ends the processing.

In the present modification, in a case where the stock quantity of the target product is not equal to or more than the predetermined number, the delivery information acquisition unit 135 acquires the delivery information regarding the delivery status of the target product, and the position acquisition unit 136 acquires the position information of the target product. Then, the estimation unit 137 estimates the scheduled arrival time of the target product, based on the position information and the delivery information of the target product, and the output unit 138 outputs the scheduled arrival time to the reception request device 230.

As a result, even if there is no stock of the target product desired by the customer, it is possible to notify the customer of the scheduled arrival time of the target product.

### Second Modification of Second Example Embodiment

Next, a modification of the present example embodiment will be described. In the present modification, in a case where the display quantity of the target product on the product shelf is less than the predetermined number and the stock quantity of the target product is not equal to or more than the predetermined number, logistics information or the scheduled arrival time of the target product is output not only to the reception request device 230 but also to other customers.

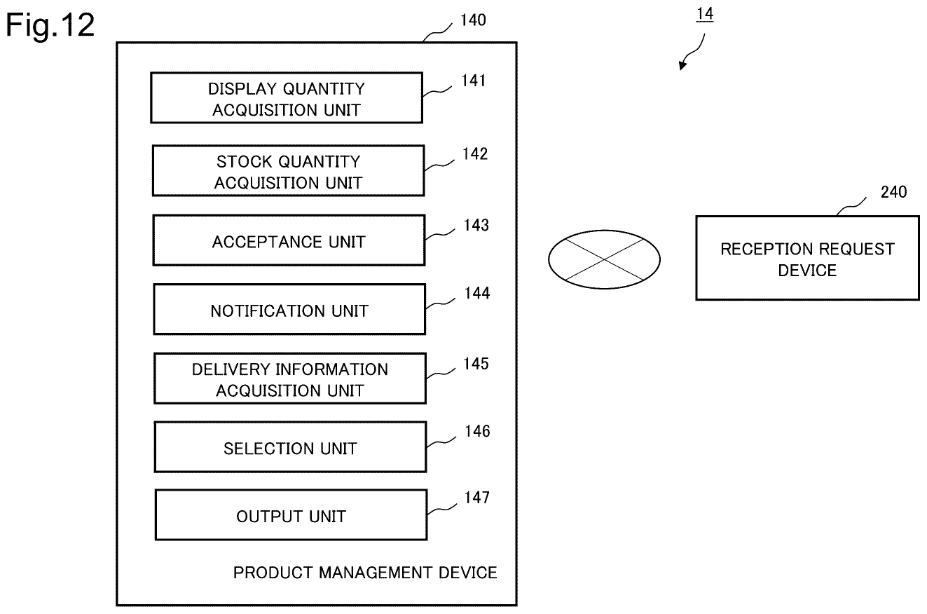

FIG. 12 is a block diagram illustrating a product management system 14 according to another modification of the second example embodiment. A function of each of a product management device 140 and a reception request device 240 in the product management system 14 can be, of course, achieved by hardware, similarly to the computer device illustrated in FIG. 2 and can be achieved by a computer device based on program control and software.

Referring to FIG. 12, the product management device 140 includes a display quantity acquisition unit 141, a stock quantity acquisition unit 142, an acceptance unit 143, a notification unit 144, a delivery information acquisition unit 145, a selection unit 146, and an output unit 147. In the product management device 140, the display quantity acquisition unit 141, the stock quantity acquisition unit 142, the acceptance unit 143, the notification unit 144, and the delivery information acquisition unit 145 have configurations similar to those of the related components in the second example embodiment. In the present modification, it is assumed that the customer be a customer having a customer terminal in which an application program for shopping that can be used at the store where the reception of the target product is requested is installed.

The selection unit 146 selects another customer who is likely to purchase the target product. In a case where the stock quantity of the target product is not equal to or more than the predetermined number, the selection unit 146 selects the another customer who is likely to purchase the target product, based on at least one of position information of the customer, a purchase history of the customer, and an action history of the customer. Each of the position information of the customer, the action history of the customer, and the purchase history of the customer is collected by a function on the application program for shopping at predetermined intervals and is stored in the storage device 505.

The position information of the customer is the position information obtained by the GPS of the customer terminal and is acquired, for example, in units of several minutes to several hours. Although the action history of the customer is similarly the position information obtained by the GPS of the customer terminal, the action history is information from which a periodic action pattern of the customer can be grasped, for example, the customer visits the store where the reception of the target product is requested at a specific time on a specific day. The purchase history of the customer is, for example, information regarding a purchased product paid by the customer terminal.

In a case of selecting another customer based on the position information of the customer, for example, the selection unit 146 selects a customer within a predetermined distance from the store where the reception is requested as the another customer. In a case of selecting the another customer based on the action history of the customer, the selection unit 146 selects a customer expected to approach the store within a predetermined time, for example, based on the action pattern of the customer, as the another customer. In a case of selecting the another customer based on the purchase history of the customer, for example, the selection unit 146 selects a customer who has purchased a product in the same category as the target product a predetermined number of times or more, as the another customer. These methods for selecting the another customer are examples of the customer who is likely to purchase the target product, and the selection unit 146 may select a customer who satisfies another condition.

The output unit 147 outputs the delivery information of the target product to the selected another customer, in addition to the reception request device 240 which is a transmission source of the reception request of the target product. In a case of outputting the delivery information of the target product to the another customer, the output unit 147 may issue a notification on the application program for shopping.

In the present modification, the selection unit 146 selects the another customer who is likely to purchase the target product, and the output unit 147 outputs the delivery information of the target product to the selected another customer, in addition to the reception request device 240 which is the transmission source of the reception request of the target product. As a result, it is possible to prompt a customer other than the customer who desires to purchase the target product, to purchase the target product.

In the second example embodiment, the above modifications may be combined. That is, the product management device 140 in FIG. 12 may further include the position acquisition unit and the estimation unit, and the output unit 147 may output the estimated arrival time of the target product, to the selected another customer.

While the present disclosure has been particularly shown and described with reference to each of the example embodiments, the present disclosure is not limited to these example embodiments. The forms and details of the present disclosure may include example embodiments to which various changes that can be understood by those of ordinary skill in the art without departing from the spirit and scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the described order does not limit the order in which the plurality of operations is executed. Therefore, when each example embodiment is carried out, the order of the plurality of operations can be changed within a range that does not interfere with the content.

Some or all of the above-described example embodiments may be described as the following Supplementary Notes, but are not limited to the following Supplementary Notes.

### Supplementary Note 1

A product management device including:
display quantity acquisition means for acquiring a display quantity, on a product shelf, of a target product for which a reception request has been received from a customer;
stock acquisition means for acquiring stock information of the target product, in a case where the display quantity is less than a predetermined number;
acceptance means for accepting the reception request, in a case where a stock quantity of the target product is equal to or more than a predetermined number; and
notification means for notifying at least any one store terminal of delivery information of the target product, in a case where the reception request has been accepted.

### Supplementary Note 2

The product management device according to supplementary note 1, in which the notification means notifies at least one of a place where and a date and time when the target product is received, as the delivery information.

### Supplementary Note 3

The product management device according to supplementary note 1 or 2, in which in a case where it takes a predetermined time or more to receive the target product, the acceptance means does not accept the reception request.

### Supplementary Note 4

The product management device according to any one of supplementary notes 1 to 3, further including delivery acquisition means for acquiring delivery information regarding a delivery status of the target product; and
output means for outputting the delivery information.

### Supplementary Note 5

The product management device according to supplementary note 4, in which in a case where the stock quantity of the target product is not equal to or more than the predetermined number, the delivery acquisition means acquires the delivery information regarding the delivery status of the target product.

### Supplementary Note 6

The product management device according to supplementary note 4 or 5, further including:
position acquisition means for acquiring position information of the target product; and
estimation means for estimating a scheduled arrival time of the target product, based on the delivery information and the position information, in which
the output means outputs the scheduled arrival time.

### Supplementary Note 7

The product management device according to supplementary note 5 or 6, in which the output means further outputs a screen for accepting the reception request of the target product, and
the acceptance means further accepts the reception request input into the screen.

### Supplementary Note 8

The product management device according to any one of supplementary notes 4 to 7, further including selection means for selecting another customer who is likely to purchase the target product, in which
the output means further outputs the delivery information of the target product to a terminal device of the selected another customer.

### Supplementary Note 9

A product management system including a reception request device and the product management device according to any one of supplementary notes 1 to 8, in which
the reception request device includes a display device that is provided on the product shelf of the store and has a button or a touch panel function, and
the product management system including:
transmission means for transmitting the reception request of the target product, to the product management device, in a case where the reception request of the target product is made by the button or the display device.

### Supplementary Note 10

The product management system according to supplementary note 9, in which the reception request device includes a button associated with each product, and
in a case where the button is pressed, a reception request of a target product associated with the button is transmitted to the product management device.

### Supplementary Note 11

A product management method performed by a computer including:
acquiring a display quantity, on a product shelf, of a target product for which a reception request has been received from a customer;
acquiring stock information of the target product, in a case where the display quantity is less than a predetermined number;
accepting the reception request, in a case where a stock quantity of the target product is equal to or more than a predetermined number; and
notifying at least any one store terminal of delivery information of the target product, in a case where the reception request has been accepted.

### Supplementary Note 12

A recording medium storing a program for causing a computer to execute processing including:
acquiring a display quantity, on a product shelf, of a target product for which a reception request has been received from a customer;
acquiring stock information of the target product, in a case where the display quantity is less than a predetermined number;
accepting the reception request, in a case where a stock quantity of the target product is equal to or more than a predetermined number; and
notifying at least any one store terminal of delivery information of the target product, in a case where the reception request has been accepted.

### Reference Signs List

10, 11, 12, 13, 14 product management system
100, 110, 120, 130, 140 product management device
101, 111, 121, 131, 141 display quantity acquisition unit
102, 112, 122, 132, 142 stock quantity acquisition unit
103, 113, 123, 133, 143 acceptance unit
104, 114, 124, 134, 144 notification unit
125, 135, 145 delivery information acquisition unit
126, 138, 147 output unit
136 position acquisition unit
137 estimation unit
146 selection unit
210, 220, 230, 240 reception request device
500 computer device
501 CPU
502 ROM
503 RAM
504 program
505 storage device
506 recording medium
507 drive device
508 communication interface
509 input/output interface
510 bus

What is claimed is:

1. A product management device comprising:
at least one memory storing instructions; and
at least one processor configured to execute the instructions to:
acquire a display quantity, on a product shelf, of a target product for which a reception request has been received from a customer;
acquire stock information of the target product, in a case where the display quantity is less than a predetermined number;
accept the reception request, in a case where a stock quantity of the target product is equal to or more than a predetermined number; and
notify at least any one store terminal of delivery information of the target product, in a case where the reception request has been accepted.

2. The product management device according to claim 1,
wherein the at least one processor is further configured to execute the instructions to:
notify at least one of a place where and a date and time when the target product is received, as the delivery information.

3. The product management device according to claim 1, or
wherein the at least one processor is further configured to execute the instructions to:
not accept the reception request, in a case where it takes a predetermined time or more to receive the target product.

4. The product management device according to claim 1,
wherein the at least one processor is further configured to execute the instructions to:
acquire delivery information regarding a delivery status of the target product; and
output the delivery information.

5. The product management device according to claim 4,
wherein the at least one processor is further configured to execute the instructions to:
acquire the delivery information regarding the delivery status of the target product, in a case where the stock quantity of the target product is not equal to or more than the predetermined number. information

6. The product management device according to claim 4,
wherein the at least one processor is further configured to execute the instructions to:
acquire a position information of the target product;
estimate a scheduled arrival time of the target product, based on the delivery information and the position information; and
output the scheduled arrival time.

7. The product management device according to claim 5,
wherein the at least one processor is further configured to execute the instructions to:
output a screen for accepting the reception request of the target product; and
accept the reception request input into the screen.

8. The product management device according to claim 4,
wherein the at least one processor is further configured to execute the instructions to:
select another customer who is likely to purchase the target product; and
output the delivery information of the target product to a terminal device of the selected another customer.

9. A product management system comprising:
the product management device according to claim 1; and
a reception request device including:
a display device that is provided on the product shelf of the store and has a button or a touch panel function;
at least one memory storing instructions; and
at least one processor configured to execute the instructions to,
transmit the reception request of the target product, to the product management device, in a case where the reception request of the target product is made by the button or the display device.

10. The product management system according to claim 9, wherein the reception request device includes a button associated with each product, and
the at least one processor of the reception request device is further configured to execute the instructions to,
transmit a reception request of a target product associated with the button to the product management device, in a case where the button is pressed.

11. A product management method comprising:
by a computer,
acquiring a display quantity, on a product shelf, of a target product for which a reception request has been received from a customer;
acquiring stock information of the target product, in a case where the display quantity is less than a predetermined number;
accepting the reception request, in a case where a stock quantity of the target product is equal to or more than a predetermined number; and
notifying at least any one store terminal of delivery information of the target product, in a case where the reception request has been accepted.

12. A non-transitory recording medium recording a program for causing a computer to execute the steps of:
acquiring a display quantity, on a product shelf, of a target product for which a reception request has been received from a customer;
acquiring stock information of the target product, in a case where the display quantity is less than a predetermined number;
accepting the reception request, in a case where a stock quantity of the target product is equal to or more than a predetermined number; and
notifying at least any one store terminal of delivery information of the target product, in a case where the reception request has been accepted.
